(19) United States
(12) Patent Application Publication
(10) Pub. No.: US 2007/0131767 A1
(43) Pub. Date: Jun. 14, 2007

(54) System and method for media card communication

(76) Inventor: Neil Morrow, San Jose, CA (US)

Correspondence Address: WAGNER, MURABITO & HAO LLP, Third Floor, Two North Market Street, San Jose, CA, 95113, US

(21) Appl. No.: 11/607,339

(22) Filed: Nov. 30, 2006

Related U.S. Application Data
(60) Provisional application No. 60/748,383, filed on Dec. 7, 2005.

(51) Int. Cl. G06K 7/06

(52) U.S. Cl. 235/441

(57) ABSTRACT

A system and method for media card communication is disclosed. The system for communicating with a media card includes a software component, a controller, a signal interface, and a data device. The software issues a request and transmits it to the controller. The request is further transferred from the controller to the data device. The data device is coupled to the controller through the serial interface. The data device is further coupled to the media card. According to the request, the data device exchanges data with the controller and the media card.

### RELATED APPLICATIONS

This application claims the benefit of U.S. Provisional Application No. 60/748,383, filed on Dec. 07, 2005, the specification of which is hereby incorporated in its entirety by reference.

### BACKGROUND OF THE INVENTION

1. Field of the Invention

The present invention relates to a system capable of media card connectivity, and more particularly to a system equipped with a media card interface and media card control devices.

2. Description of the Related Art

Media cards have become a very popular format for storing digital content, useful in applications such as digital photography, digital audio players, and personal digital assistant (PDA) systems. Several systems today include connectivity for a range of media cards, including xD-Picture™ Card, SmartMedia™, CompactFlash, Memory Stick™, Secure Digital (SD), and MultiMediaCard™ (MMC). Often, the systems are equipped with a combo-socket that can accept more than one format. Also, many systems include multiple socket connectors to offer simultaneous system connectivity for media cards of various formats.

A conventional system including media card connectivity utilizes a media card controller. A conventional media card controller includes a host bus interface, a set of programming registers for software control, and a set of media control logic and state machine hardware that communicates with a media card through a media card bus interface. The host bus interface is often compatible with USB or PCI specifications. The set of programming registers may comply with an industry standard specification, such as a USB device class specification for bulk storage devices or a host programming interface defined by the Secure Digital Association for programming an SD device, or an MMC device. Driven by the software control, the set of media control logic and state machine hardware is generally equipped to map the control and data exchange to the communication protocol defined for a particular media card type and the communication protocol utilizes input/output signals of the media card bus interface.

However, the conventional unified media card connectivity controller usually has a high packaging and silicon costs. Furthermore, the conventional media card controller typically requires a large terminal count to accommodate the media card with a parallel data bus interface, which gives rise to an increased cost. Additionally, the conventional unified media card connectivity controller may integrate other connectivity functions, such as PC Card control, IEEE1394 control, and/or Smart Card control. Often, a single system motherboard is used by a system manufacturer across models with different connectivity features, resulting in the need for packaging compatibility (i.e. footprint compatibility, pin-compatibility) for a family of connectivity controllers that offers a range of connectivity features, including media card connectivity.

### SUMMARY OF THE INVENTION

In one embodiment, there is provided a method for a system to exchange data with a media card. The method includes the loading exchange data, serializing the exchange data, de-serializing the exchange data, and storing the exchange data. Through the serializing step, a predetermined bit width of the exchange data (for example 2 bits) are transferred at each transfer cycle (thus 2 terminals are sufficient for data exchange).

In another embodiment, there is provided a system for communicating with a media card. The system includes a software component, a controller, a signal interface, and a data device. The software issues a request and transmits it to the controller. The request is transferred from the controller to the data device. The data device is coupled to the controller through the serial interface. The data device is also coupled to the media card. According to the request, the data device exchanges data between the controller and the media card.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of an exemplary system according to one embodiment of the present invention.

FIG. 2 is a block diagram of a host bus controller and DEC device in FIG. 1 according to one embodiment of the present invention.

FIG. 3 is an exemplary table depicting a single byte read transfer SIF protocol according to one embodiment of the present invention.

FIG. 4 is an exemplary table depicting a single byte write transfer SIF protocol according to one embodiment of the present invention.

FIG. 5 is an exemplary table depicting 512 byte read transfer SIF protocol according to one embodiment of the present invention.

FIG. 6 is an exemplary table depicting 512 byte write transfer SIF protocol according to one embodiment of the present invention.

FIG. 7 is a waveform depicting the byte write transfer SIF protocol in FIG. 4.

FIG. 8 is a flow chart depicting data exchange of the system in FIG. 1.

### DETAILED DESCRIPTION OF THE INVENTION

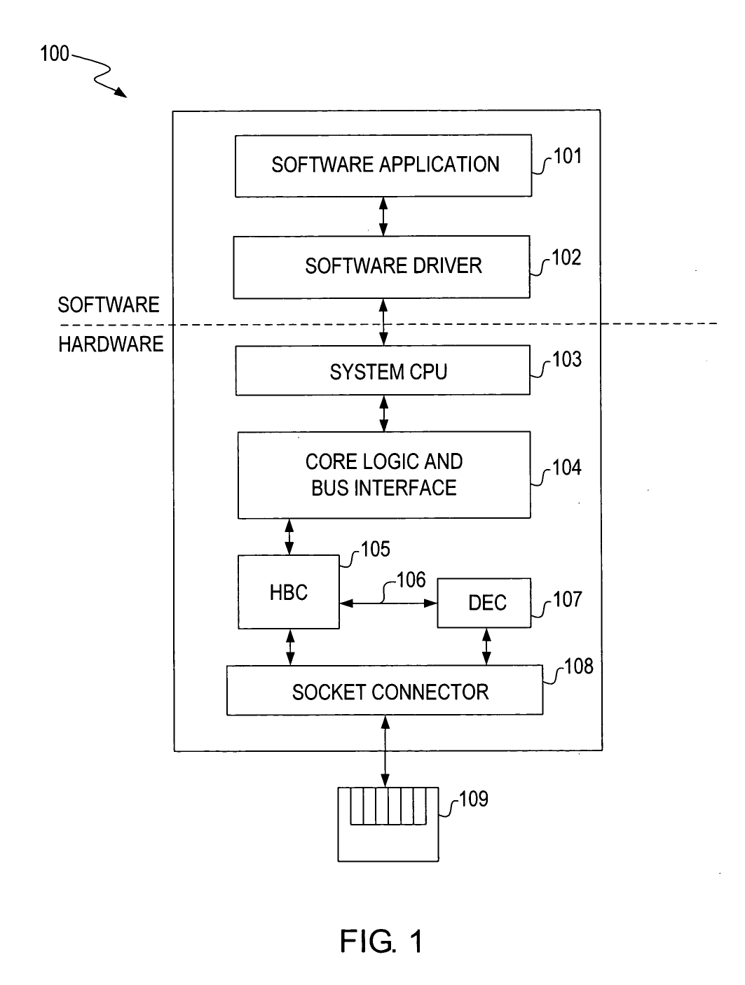

FIG. 1 illustrates a block diagram of an exemplary system 100. The system 100, for example, a computer system, has an architecture containing software and hardware components. The software components include at least one software application 101 and software driver 102. The hardware components include a system central processing unit (CPU) 103, system core logic and bus interface 104, a host bus controller (HBC) 105, a serial interface (SIF) 106, a data expansion companion (DEC) device 107 and a socket connector 108. The architecture is generally useful to connect a media card 109 with a parallel data bus interface to the software application 101. In one embodiment, the media card 109 can be a xD-Picture™ Card XD and/or SmartMedia™ SM. In other embodiments, other type cards, including but not limited to CompactFlash, Memory Stick™, Secure Digital, and MultiMediaCard™ can be employed. When the connectivity is set up, the information held on the media card 109 may be accessed by the software application 101, such as additional data storage capacity, or the application of input or output capability to provide connectivity features such as personal access network (PAN), code division multiple access (CDMA), local area network (LAN), wide area network (WAN) and cameras.

To initiate the connectivity, the media card 109 is inserted to the system 100 through the socket connector 108. The socket connector 108 may be a combo connector capable of accepting more than one media type, such as a 4-in-1 connector that can accept XD, Secure Digital SD, MultiMediaCard™ MMC, and Memory Stick. The software components operate on the system CPU 103. Typically, the system CPU can be an Intel or AMD CPU. The system CPU 103 is connected to the HBC 105 through a set of core logic in the system core logic and bus interface 104, mapping addresses from the CPU operations to a computer bus input/output interface such as USB, PCI, or PCI Express. The HBC 105 provides a set of programming registers, and a set of media control signals that connect to the socket connector 108. The set of media control signals will be discussed below. The HBC 105 further connects to the DEC device 107 by a signal interface 106. The preferred signal interface is a serial interface (SIF) connection, operating a communication protocol to exchange data requests and data elements between the HBC 105 and the DEC device 107, whereas data elements are further exchanged between the media card 109 and the DEC device 107 by means of data signal connections. One embodiment of the communication protocol of the SIF connection 106 is discussed below.

Furthermore, the software application 101 don't operate on the system CPU 103 to access the set of programming registers of the HBC 105 directly, as the function is provided by the software driver 102 that abstracts the physical details of the HBC 105 from the high level protocol to use the media card 109 for data exchange.

The aforementioned architecture of the system 100 is called a split controller architecture, whereas media card connectivity is realized by a two-chip approach, that includes the HBC 105 and the DEC device 107. The split controller architecture offers a system cost benefit since packaging and silicon costs of the conventional unified media card connectivity controller exceed the combined packaging and silicon costs of the HBC 105 and DEC device 107. Additionally, the DEC device 107 may extract input/output terminals from a primary controller packaging terminal count, whereas the HBC 105 is in one embodiment compatible with the primary controller packaging configuration. Thus, by introducing the DEC device 107, the terminal count of the primary controller packaging is reduced significantly. This reduction in terminal count equates to system cost saving when the media card connectivity is featured on a relatively small number of models.

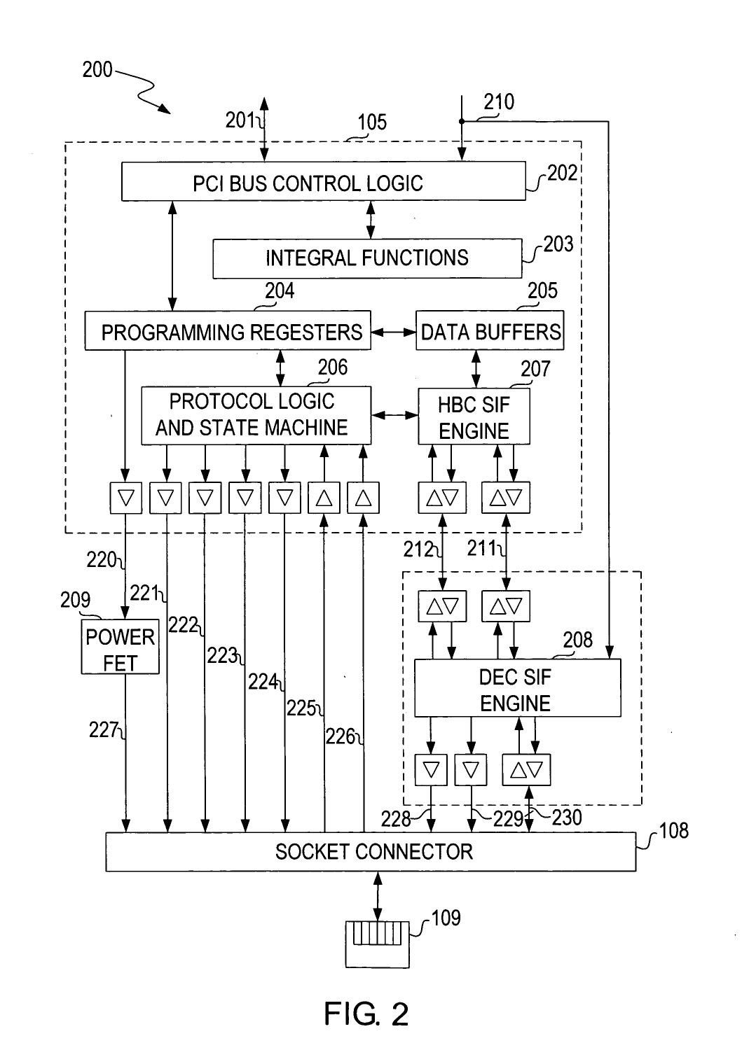

FIG. 2 illustrates a block diagram 200 of the HBC 105 and the DEC device 107 in FIG. 1. In one embodiment, HBC 105 utilizes a PCI bus interface containing data and control signals 201 as well as a PCI clock timing reference 210. The HBC 105 can be equipped with PCI bus control logic 202, and can provide PCI connectivity to other integral functions 203, whereas the integral functions 203 can include PC Card control, IEEE1394 control, Secure Digital SD control, Memory Stick MS control, and Smart Card control. The HBC 105 can also include a set of programming registers 204 to provide control and status communication to the system 100, as well as a data exchange port. Data written to the data exchange port is placed in the data buffers 205, and data read from the data exchange port is read from the data buffers 205.

In one embodiment, programming register accesses can directly control an output of the HBC 105, whereas a power enable signal 220 is controlled by a register in the set of programming registers 204. The power enable signal 220 is connected to the control port of a power FET 209, a transistor to switch ON and OFF the power delivery from a power source 227 to the socket connector 108. In an embodiment of the system 100, the power source 227 can power both the media card 109 and the DEC device 107.

Additionally, programming register accesses communicate action requests to a protocol logic and state machine 206 where media control input and output signals exhibit a protocol compatible with a media card specification. The protocol logic and state machine 206 directly control a command latch enable CLE output 221, an address latch enable ALE output 222, a media card enable CE# output 223, and a write protection WPO output 224. A media ready signal R/B# 225 and a write protection input signal WPI# 226 provide conditional control of the protocol logic and state machine 206 consistent with the media card specification.

Furthermore, in one embodiment, the HBC 105 indirectly controls a media data path 230 and data strobes 228 and 229 by means of initiating data exchanges over the SIF interface 106. To this end, the HBC 105 includes an HBC SIF engine 207, generally made up of logic and state machine hardware, to adapt to the SIF protocols. In one embodiment, data exchange between the DEC device 107 and the data buffers 205 is accomplished under indirect control by the protocol logic and state machine 206. The SIF interface 106 may be realized by a first input/output SIFO signal 211 and a second input/output SIF1 signal 212. In one embodiment, these signals make up the two-wire bi-directional communication link between the HBC 105 and the DEC device 107.

Those skilled in the art will recognize that the serial interface 106 may be realized by other conventional configurations. Additionally, the serial interface 106 can be an exemplary communication protocol employed between the HBC 105 and the DEC device 107. In one embodiment, there may be other signal interface structures adapted thereto as long as the reduction in terminal count of the HBC 105 is achieved.

The protocol operating on the SIF interface 106 is consistent with the design of the DEC SIF engine 208 in the DEC device 107. The DEC SIF engine 208 can be made up of logic and state machine hardware, to perform data exchange with the media card 109 by means of a read enable strobe RE# output 228, a write strobe WE# output 229, and the input/output data path 230, that is a byte-wide data port DATA [7:0], to exchange data with the media card 109, adapted to the SIF protocols.

Also, as illustrated in FIG. 2, the HBC 105 and the DEC device 107 can be equipped with output signal buffers, input signal buffers, and input/output signal buffers, respectively placed in output signal paths, input signal paths and bi-directional signal paths.

Those skilled in the art will recognize that the HBC 105 is conventionally connected directly to the media card 109 through the socket connector 108. Thus, the HBC 105 is equipped with a large terminal count to be compatible with the media card specification. In the architecture depicted herein, the HBC 105 is connected indirectly to the media card 109 through the DEC device 107, which can communicate with the HBC 105 through the serial interface 106 and with the media card 109 through the socket connector 108. Thus, the terminal count of the HBC 105 is reduced significantly, and consequently cost saving is achieved.

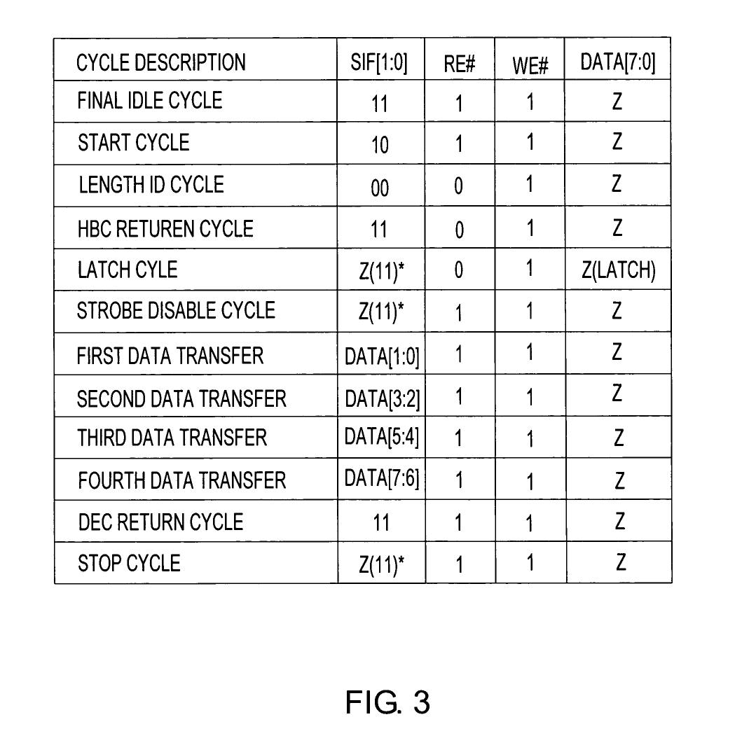

Exemplary communications protocols according to one embodiment is the subject of FIGS. 3-6, where each illustration assumes the DEC device 107 connection to the socket connector 108 including the read enable strobe RE# 228 that is active low, the write enable strobe WE# 229 that is an active low, and the DATA[7:0] path connection 230. In many cycles of the illustrations, the DATA[7:0] interface 230 is in a high-impedance, or Z-state, whereas it is preferred that conventional pull-up or pull-down resistors maintain the DATA[7:0] interface 230 at a valid logic level during these conditions. Additionally, the illustrations assume a two-wire bi-directional communication protocol with appropriate turn-around cycles and pull-up resistors, whereas the HBC 105 is the master controller of the SIF interface 106, in that the exchange requests, that is, packets are initiated by the HBC 105. Implementation of such protocol and general assumptions discussed above are within the knowledge of those skilled in communication protocols.

FIG. 3 illustrates a single byte read SIF transfer protocol of the system 100 according to one embodiment of the present invention. An eleven cycle packet plus a final idle cycle is depicted. In the final idle cycle, the SIF interface 106 is driven by the HBC 105 at a value of two-bit 11 (2′b11), the data strobes RE# 228 and WE# 229 are driven de-asserted by the DEC 107 device, and the DATA[7:0] interface 230 is in the high-impedance state, or the Z state. The start cycle communicates the beginning of a packet exchange, and the exchange type is a read by means of the HBC 105 driving a value of 2′b10 on the SIF interface 106. The DEC device 107 makes no change to the read enable strobe RE# 228, write enable strobe WE# 229, and the DATA[7:0] interface 230 during the start cycle. The length identification cycle communicates that the exchange is a single byte exchange by the HBC 105 driving a value of 2′b00 on the SIF interface 106. The DEC device 107 initiates the byte read acquisition from the media card 109 during this cycle by asserting the RE# strobe 228. The HBC 105 drives the SIF interface 106 to a value of 2′b11 during the HBC return cycle, which is followed by the latch cycle where the DEC device 107 latches data from the DATA[7:0] interface 230 that is driven by the media card 109, and the media card 109 drives the data under RE# strobe control. The latch cycle and strobe disable cycle are both turnaround cycles, marked with the asterisk (*), whereas neither the HBC 105 nor the DEC device 107 drives the SIF interface 106. The RE# strobe 228 is de-asserted in the strobe disable cycle.

In the first data transfer, second data transfer, third data transfer, and fourth data transfer, the DEC device 107 transmits the byte of data acquired during the latch cycle to the HBC 105. Once the data is sent, the DEC device 107 drives the SIF interface 106 to a value of 2′b11 during the DEC return cycle, which is followed by the stop cycle. The stop cycle is a final packet cycle provided for the SIF interface 106 turnaround, whereas the cycle following the stop cycle is driven by the HBC 105.

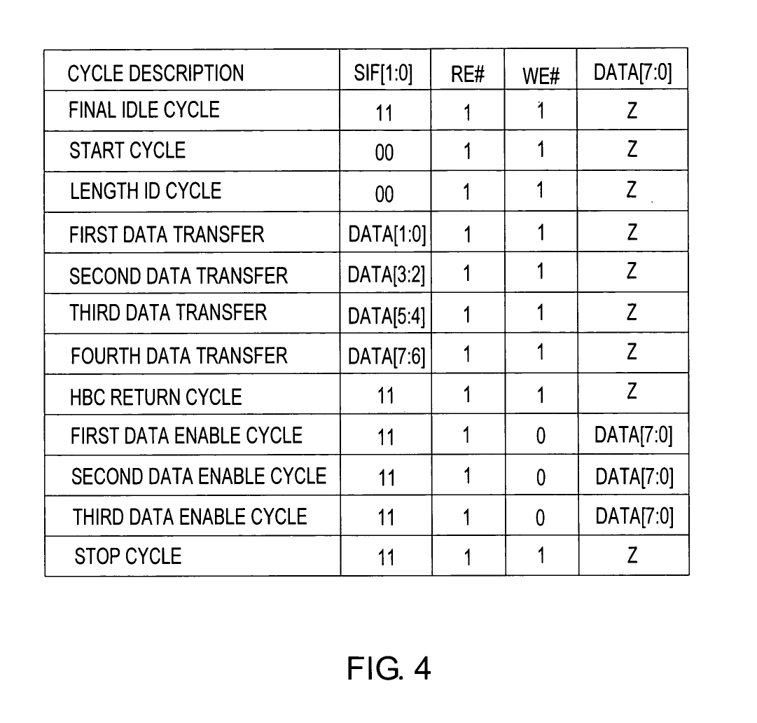

FIG. 4 illustrates a single byte write SIF transfer protocol of the system 100 according to one embodiment of the present invention. An eleven cycle packet plus a final idle cycle is depicted. The start cycle of FIG. 4 communicates the beginning of a packet exchange, and the exchange type is a write by means of the HBC 105 driving a value of 2′b00 on the SIF interface 106. The length identification cycle communicates that the exchange is a single byte exchange by the HBC 105 driving a value of 2′b00 on the SIF interface 106.

In the first data transfer, second data transfer, third data transfer, and fourth data transfer, the HBC 105 transmits the byte of data to write to the DEC device 107. Once the data is sent, the HBC 105 drives the SIF interface 106 to a value of 2′b11 during the HBC return cycle.

The DEC device 107 initiates the byte write exchange to the media card 109 during the first data enable cycle by asserting the WE# strobe 229 and driving the data byte to the DATA[7:0] interface 230. The preferred media card can accept the data byte when this condition persists for three cycles. Thus, a second data enable cycle and third data enable cycle are included with a common condition of the first data enable cycle. The preferred single byte write SIF transfer protocol concludes with a stop cycle whereas the DEC device 107 de-asserts the WE# strobe 229 and returns the DATA[7:0] interface 230 to the high-impedance state, Z.

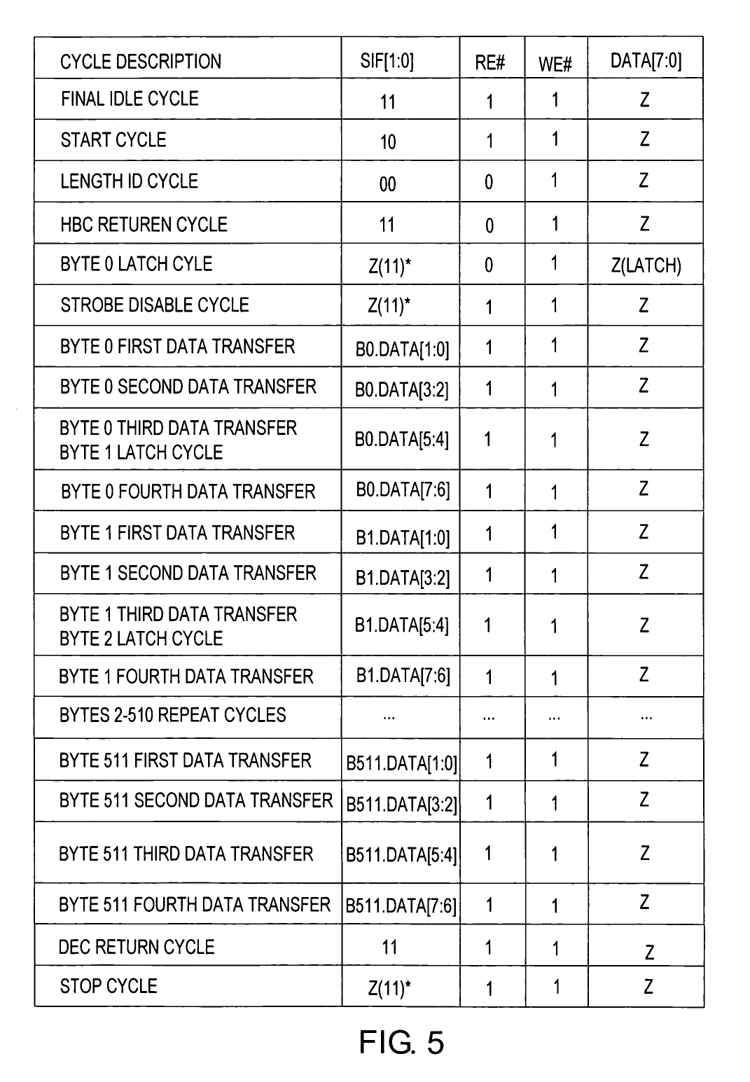

FIG. 5 illustrates a 512 byte read SIF transfer protocol of the system 100 according to one embodiment of the present invention. The 512 byte read SIF transfer protocol includes the final idle cycle and the start cycle common to those included in the byte read protocol of FIG. 3. The length identification cycle communicates that the exchange is a 512 byte exchange by the HBC 105 driving a value of 2′b01 on the SIF interface 106. The DEC device 107 initiates the first byte read acquisition from the media card 109 during this cycle by asserting the RE# strobe 228, followed by the HBC return cycle.

The first data byte is latched during the byte 0 latch cycle followed by the strobe disable cycle. The DEC device 107 latches one byte of data every four cycles, as illustrated in FIG. 5, whereas the second byte is latched in the byte 1 latch cycle, the third byte is latched in the byte 2 latch cycle, and the repetition is maintained through the repeat cycles illustrated in FIG. 5. The cycle immediately following each of the 512 latch cycles includes a disabled RE# strobe 228, whereas the RE# strobe 228 is enabled for three clocks and disabled for one out of the four clock latching cycles discussed above and illustrated in FIG. 5.

In the byte zero first data transfer, byte zero second data transfer, byte zero third data transfer, and byte zero fourth data transfer, the DEC device 107 transmits the byte of data acquired during the byte 0 latch cycle to the HBC 105. As illustrated in FIG. 5, this data transmission pattern continues for bytes one through byte 511, followed by the DEC return cycle and the read stop cycle common to those included in the byte read protocol of FIG. 3.

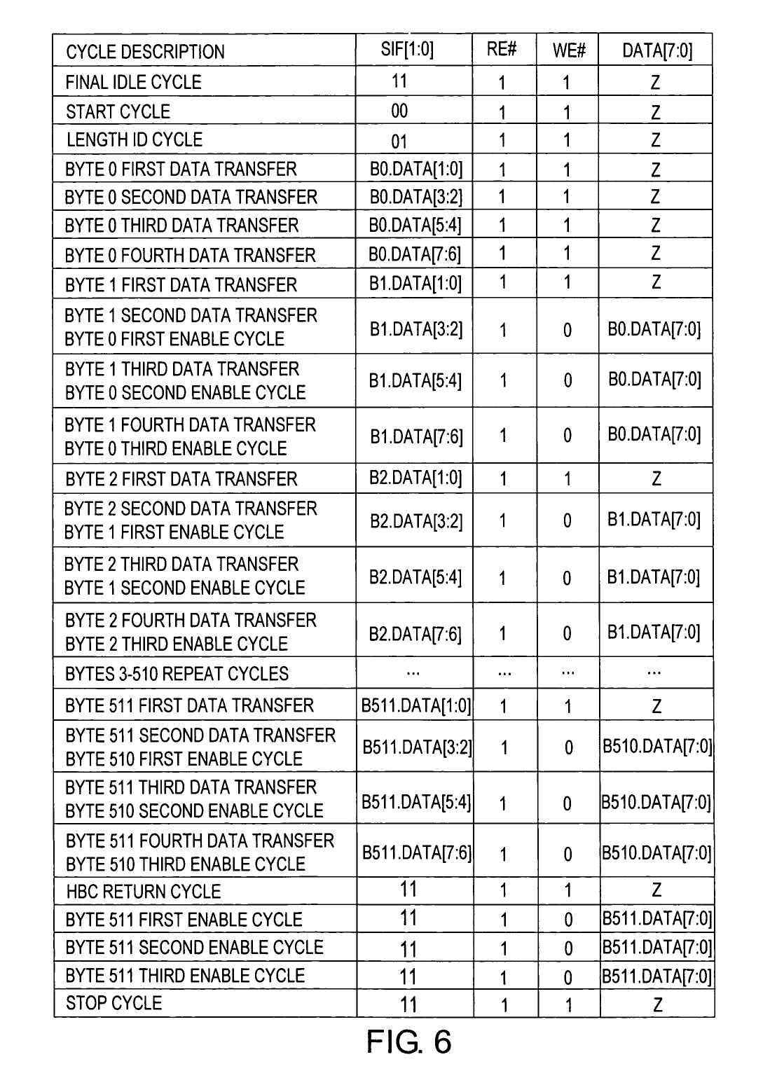

FIG. 6 illustrates a 512 byte write SIF transfer protocol of the system 100. The 512 byte write SIF transfer protocol includes the final idle cycle and the start cycle common to those included in the byte write protocol of FIG. 4. The length identification cycle communicates that the exchange is a 512 byte exchange by the HBC 105 driving a value of 2′b01 on the SIF interface 106.

In the byte zero first data transfer, byte zero second data transfer, byte zero third data transfer, and byte zero fourth data transfer, the HBC 105 transmits the first byte of data to write to the DEC device 107. As illustrated in FIG. 6, this data transmission pattern continues for bytes one through byte 511, followed by the HBC return cycle.

Two cycles following a data byte is completely received, by the corresponding “fourth” data transfer, the DEC device 107 initiates the data byte write to the media card 109 by asserting the WE# strobe 229 and driving the corresponding data byte to the DATA[7:0] interface 230. As in the single byte write protocol of FIG. 4, the write enable condition persists for three cycles, followed by a cycle with the WE# strobe 229 de-asserted and the DATA[7:0] interface 230 returned to the high-impedance state. This four cycle repetition occurs 512 times, as illustrated in FIG. 6. Following the third byte 511 enable cycle, the stop cycle is performed to conclude the 512 byte write protocol common to that in FIG. 4.

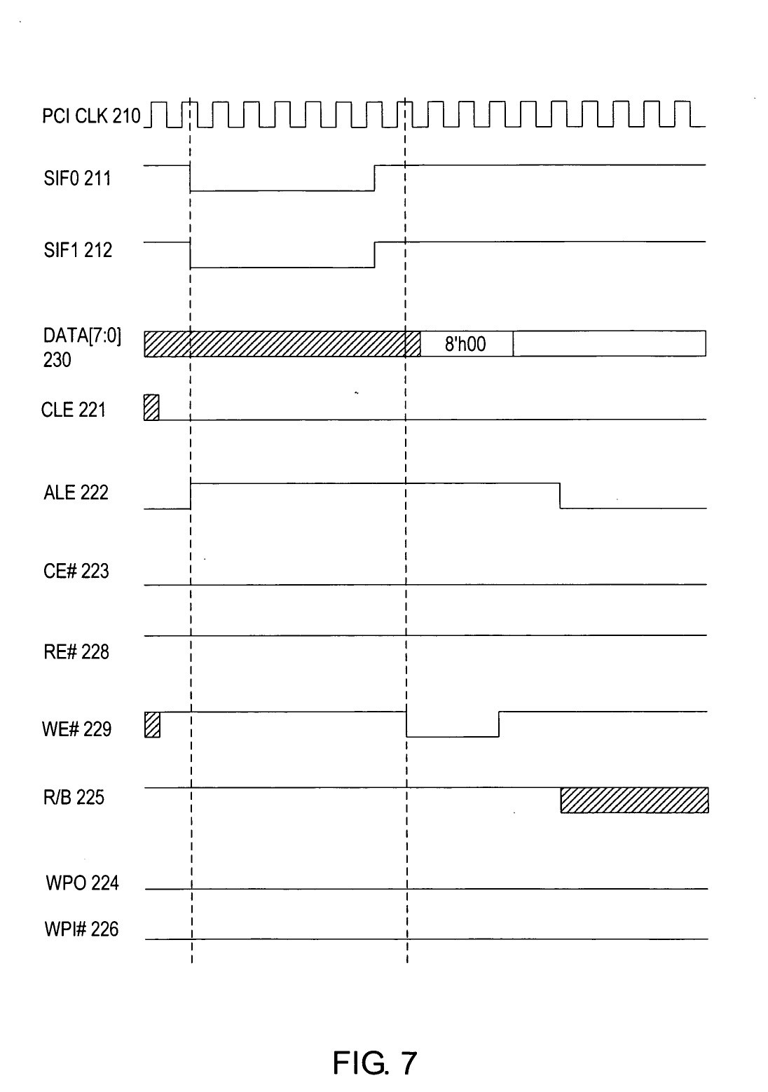

FIG. 7 illustrates a waveform of an exemplary byte write SIF transfer that is consistent with the protocol of FIG. 4 according to one embodiment. Here, the HBC 105 has asserted the ALE signal 222 during this transfer, thus, this byte write is an address phase for the media card 109 used to address a particular sector of data. Similarly, those skilled in the art will recognize other media control signals have been set accordingly as shown in FIG. 7, including the command latch enable CLE signal 221, the media card enable signal CE# 223, the write protection signal WPO 224, the media ready signal R/B# 225 and the write protection input signal WPI# 226.

A conventional controller generally does not implement a seven cycle delay between assertion of ALE 222 and the assertion of WE# 229 to the media card 109, as illustrated in FIG. 7. Conventionally, the address information is available immediately when ALE 222 is asserted, and a two cycle delay to WE# 229 assertion following ALE 222 assertion is consistent with timing specifications. However, the SIF protocol is herein used to transfer the byte to the DEC device 107, adding a seven cycle latency to WE# 229 and DATA[7:0] interface 230 presentation to the media card during this addressing phase. The HBC 105 performs this media control signal synchronization, as ALE 222 is synchronized to the DATA[7:0] interface 230 exchange to accommodate the SIF protocol latency. Synchronization is adapted to a pre-determined SIF protocol, such as the preferred protocols presented in FIGS. 3-6, and illustrated in FIG. 7.

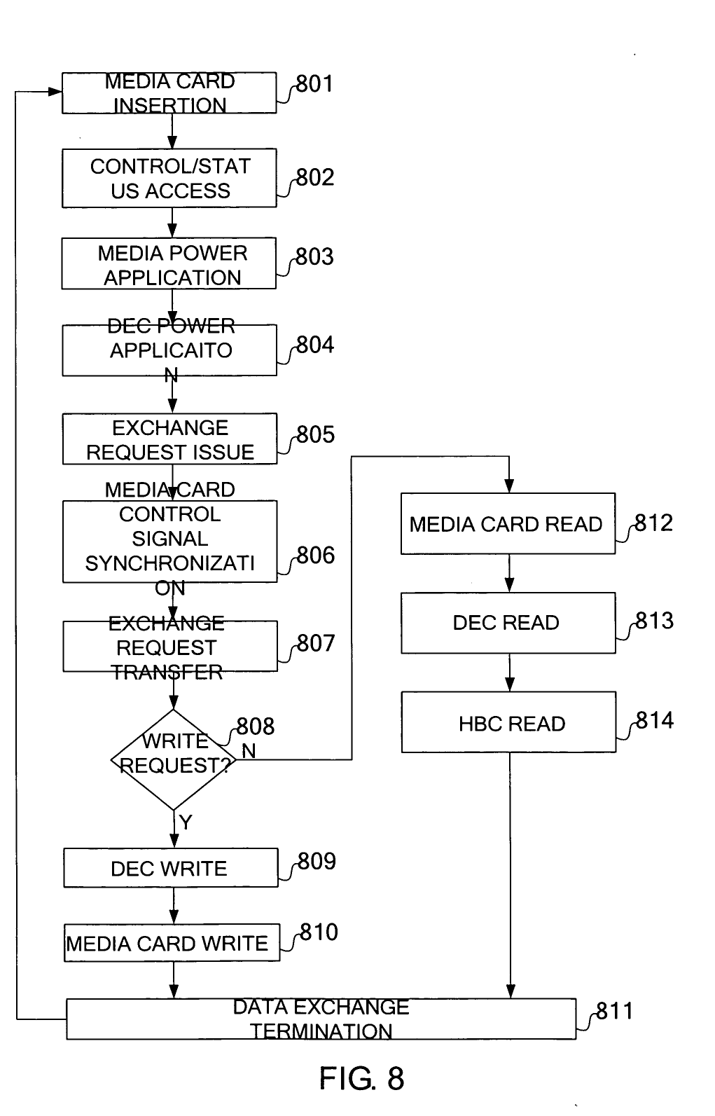

FIG. 8 is a flow chart depicting a method for the system 100 to communicate with the media card 109, according to one embodiment, whereas the exemplary system is a personal computer system, and the exemplary media card 109 is an xD-Picture XD card.

The method includes an initial insertion step 801 whereas the media card 109 is inserted into the empty socket connector 108. The insertion step 801 involves the HBC 105 notification of the media card insertion, and generally results in the activation of a control/status register and/or interrupt event to the system CPU 103. The HBC 105 communicates the insertion event to the computer system during a first control/status access step 802. In one embodiment, software components operating on the computer system performs a data exchange with the control/status register in the HBC 105 and learns that the insertion step 801 has occurred.

A media power application step 803 is performed to apply power to the media card 109. Since one embodiment of the system 100 employs a common power source 227 to both the media card 109 and the DEC device 107, the media power application step 802 results in the completion of the DEC power application step 804. Generally, the power application steps are performed by a second control/status access, whereas the control/status register in the HBC 105 is programmed to control the power source. The power source 227 circuitry may be an integral part of the HBC 105, or it may be an external FET 209 that is controlled by the HBC power enable output 220.

In one embodiment, the method involves data exchange between software components operating on the computer system and the media card 109. Software applications 101 issue a read or write request to exchange a data element with the media card 109 during the exchange request step 805, the exchange request is issued to the HBC 105 through the host bus interface in the system core and bus interface 104, the host bus interface preferred to be a PCI interface. When a write request is made in the exchange request step 805, the HBC 105 latches at least one data element, where the at least one data element corresponds to the write request to the media card 109. When a read request is made in the exchange request step 805, the HBC 105 latches the read address and disconnects from the host bus, such as through a PCI target disconnect protocol defined by the PCI bus specification. When the data is acquired from the media card 109 and available in the data buffers 205, the HBC 105 delivers the data when the PCI master retries the read cycle.

In one embodiment, HBC 105 has several control signals connecting to the media card socket connector 108, as discussed above. Following the exchange request step 805, a control synchronize step 806 occurs, where the HBC 105 synchronizes a media control signal associated with the data exchange to the actual exchange between the DEC device 107 and the media card 109, for example, by extending a card enable signal 223, extending a command latch enable signal 221, or extending an address latch enable signal 222 to accommodate the inherent latency of transferring data over the SIF interface 106 while maintaining compliance with the media card timing information. The SIF protocols are known by the HBC 105, thus, the media control signal timing accommodations performed in the control synchronize step 805 are generally pre-determined in the media protocol logic and state machine 206.

The request transfer step 807 involves the HBC 105 transmitting the exchange type and data size information gathered in the exchange request step 805 to the DEC device 107, where the SIF interface 106 is used to transmit the information. This is performed in the start cycle and length ID cycle illustrated in the SIF protocol illustrations of FIGS. 3-6, as described above.

In a decision step 808, the DEC device 107 determines from the information learned in the request transfer step 807 if the exchange request is a read or a write type. In the case of a write exchange, a DEC write step 809 is performed, where the HBC 105 transmits at least one data element to the DEC device 107, as described in the two-bits-per-cycle data transmissions illustrated in the SIF protocol illustrations of FIGS. 4 and 6. For the case of a write exchange, a media card write step 810 is performed whereas the DEC device 107 asserts a data element to the data signals of the DATA[7:0] interface 230. In the preferred embodiment, the DEC device 107 further asserts the write enable WE# strobe 229 to control the byte-transfer to the media card 109 over the DATA[7:0] interface 230.

In the case of a read exchange, the DEC device 107 acquires a data element from the media card 109 after learning of the read type in the request transfer step 807 in a media card read step 812. In one embodiment, the DEC device 107 further asserts the read enable RE# strobe 228 to control the byte-transfer from the media card 109 over the DATA[7:0] interface 230 in the media card read step 812. After the data element is acquired, a DEC read step 813 is performed, where the DEC device 107 transmits at least one data element to the HBC 105, as described in the two-bits-per-cycle data transmissions illustrated in the SIF protocol illustrations of FIGS. 3 and 5. When the HBC 105 receives the data in the DEC read step 813, the data is placed in the data buffers 205, and delivered to the software components using the HBC host bus interface in a HBC read step 814, completing the read transaction.

It should be understood from the above discussion that the method described herein involves the steps of serializing and de-serializing the exchange data since the HBC 105 communicates with the system CPU through the host bus interface, the HBC 105 communicates with the DEC device 107 through the SIF interface 106, and the DEC device 107 communicates with the media card 109 through the media card interface.

FIG. 8 illustrates the exchange of one data element, where after the data exchange termination step 811 is performed by removing the media card 109 or executing the software instruction, the flow returns to the initial insertion step 801. Conceivably more than one element is transferred, and the media card write step 810 and HBC read step 814 are in fact followed my a multitude of requests, where the multitude of requests are each communicated by software components in the exchange request step 805.

In operation, the system may be adapted to various systems being capable of conducting data exchange with a media card, such as xD-Picture™ Card, SmartMedia™, CompactFlash, Memory Stick™, Secure Digital, and MultiMediaCard™. Conventionally, these media cards typically have a parallel communication interface, where a predetermined bit-width of data is exchanged between the media card and the primary controller of the system (the HBC 105 in the exemplary system 100) at each transfer cycle. Fox example, the predetermined bit-width is a byte or 8 bits. To reduce the terminal count of the primary controller and consequently to save the system cost, a data device (the DEC device 107 in the exemplary system 100) is herein placed between the media card and the primary controller. The data device communicates with the media card through the parallel communication interface, while the data device communicates with the primary controller through a signal interface with reduced terminal count, such as the serial interface 106 in the exemplary system 100. Such structure is called a split controller architecture, where media card connectivity is realized by a two-chip approach, the primary controller and the data device. The split controller architecture employs a method to exchange data with the media card involving steps to serialize and de-serialize data signals and strobe signals for connectivity to the media card.

The embodiments that have been described herein are some of the several possible embodiments that utilize this invention and they are described here by way of illustration and not of limitation. It is obvious that many other embodiments, which will be readily apparent to those skilled in the art, may be made without departing materially from the spirit and scope of the invention as defined in the appended claims. Furthermore, although elements of the invention may be described or claimed in the singular, the plural is contemplated unless limitation to the singular is explicitly stated.

What is claimed is:

1. A method for exchanging data between a system and a media card, comprising:
loading exchange data, wherein the exchange data is loaded from the media card when the media card is read, and the exchange data is loaded from the system when the media card is written;
serializing the exchange data according to a serial interface protocol;
de-serializing the exchange data according to the serial interface protocol; and
storing the exchange data, wherein the exchange data is stored in the system when the media card is read, and the exchange data is stored in the media card when the media card is written.

2. The method of claim 1, further comprising the step of enabling the data exchange.

3. The method of claim 1, wherein the serial interface protocol employs a two-wire bi-directional communication.

4. The method of claim 1, wherein the serial interface protocol comprises a byte read transfer protocol and a byte write transfer protocol.

5. The method of claim 4, wherein the byte read transfer protocol comprises:
starting a byte read, wherein a serial interface between a controller and a data device is set to have a first predetermined value;
issuing a size of the exchange data for the byte read, wherein the serial interface is set to have a second predetermined value and a read enable signal is asserted to the media card;
latching the exchange data from the media card to the data device; and
transferring the exchange data from the data device to the controller through the serial interface, wherein a predetermined bit width of the exchange data is transferred at each transfer cycle.

6. The method of claim 4, wherein a byte write transfer protocol comprises:
starting a byte write, wherein a serial interface between a controller and a data device is set to have a first predetermined value;
issuing a size of the exchange data for the byte write, wherein the serial interface is set to have a second predetermined value and a write enable signal is asserted to the media card;
transferring the exchange data from the controller to the data device through the serial interface, wherein a predetermined bit width of the exchange data is transferred at each transfer cycle; and
transferring the exchange data from the data device to the media card.

7. A method for system and media card communication, comprising the steps of:
issuing a request to a controller in the system;
transferring the request to a data device in the system;
exchanging data between the controller and the data device through a serial interface based on a serial interface protocol; and
exchanging the data between the data device and the media card, wherein the media card is adapted to use the serial interface protocol.

8. The method of claim 7, further comprising:
acquiring a media card insertion status according to a first register; and
powering the media card according to the first register.

9. The method of claim 7, further comprising:
exchanging the data between a system software and the controller.

10. The method of claim 7, further comprising:
synchronizing a media control signal associated with the request to data exchanges between the media card and the data device.

11. The method of claim 10, wherein the media control signal is a control latch enable signal or an address latch enable signal.

12. The method of claim 10, wherein the media control signal is asserted during the transferal of the request.

13. The method of claim 7, wherein the request includes information that indicates an exchange type and an exchange data size.

14. The method of claim 13, wherein the exchange type is a byte write or a byte read.

15. The method of claim 13, wherein the exchange data size is a single byte or 512 bytes.

16. The method of claim 7, wherein the request is transferred through the serial interface based on the serial interface protocol.

17. The method of claim 7, wherein a plurality of transfer cycles are executed to exchange the data between the controller and the data device, and a predetermined bit width of the data is transferred at each transfer cycle.

18. The method of claim 7, wherein the serial interface protocol uses a two-wire bi-directional communication.

19. The method of claim 7, wherein the step of exchanging the data between the data device and the media card further comprises:
asserting an enable strobe signal to the media card; and
transferring the data through a media data path in response to an assertion of the enable strobe signal.

20. The method of claim 19, wherein the enable strobe signal is a read enable strobe signal or a write enable strobe signal.

21. The method of claim 19, wherein the media data path has an 8 bit width.

22. A system for communicating with a media card, comprising:
a software component capable of issuing a request;
a controller capable of receiving the request and controlling execution of the request;
a signal interface; and
a data device coupled to the controller through the signal interface and capable of receiving the request from the controller and exchanging data with the controller through the signal interface, the data device further being coupled to the media card and being capable of exchanging the data according to the request.

23. The system of claim 22, wherein the software component further comprises at least one software application and software driver.

24. The system of claim 22, wherein the controller further comprises a first serial interface (SIF) engine coupled to the signal interface for serializing and de-serializing the data.

25. The system of claim 22, wherein the data device further comprises a second SIF engine coupled to the signal interface for serializing and de-serializing the data.

26. The system of claim 22, further comprising a socket coupling the media card to the controller and the data device, wherein the controller transmits a plurality of media control signals to the socket, and the data device transmits a plurality of strobe signals to the socket, and wherein a media data path is established between the data device and the socket for transferring the data.

27. The system of claim 26, wherein the plurality of strobe signals includes a read enable signal and a write enable signal for enabling data exchanges between the media card and the data device.

28. The system of claim 26, wherein the media data path has an 8 bit width.

29. The system of claim 22, wherein the signal interface is a two-wire bi-directional interface.

30. The system of claim 22, wherein the controller further comprises a first register for indicating the media card insertion status and enabling power delivery to the media card.

31. The system of claim 22, wherein the controller further comprises:
a set of programming registers for receiving the request; and
a protocol logic and state machine coupled to the set of programming registers, the protocol logic and state machine being capable of controlling the execution of the request according to a predetermined communication protocol of the media card.

32. A device for connecting a media card to a system, wherein the system includes a host bus controller for connecting the media card to the system, the device comprising:
a first signal interface connected to the host bus controller in the system;
a logic set connected to the first signal interface and being capable of operating a communication protocol used to control data exchanges between the media card and the system; and
a data device coupled to the host bus controller through the first signal interface and being capable of data exchange with the host bus controller, the data device further being coupled to the media card for data exchange.

33. The device of claim 32, wherein the first signal interface is a two-wire bi-directional interface.

34. The device of claim 32, wherein the logic set generates a plurality of media control signals for controlling data exchange between the media card and the system.

35. The device of claim 32, wherein the logic set is coupled to the first signal interface for controlling data exchange between the host bus controller and the data device according to a serial interface protocol.

36. The device of claim 35, wherein the data device exchanges data with the media card and wherein the media card is adapted to use the serial interface protocol.

37. The device of claim 32, wherein the data device generates a read enable signal and a write enable signal for enabling data exchanges between the data device and the media card.

38. The device of claim 32, further comprising a media data path that is established between the data device and the media card.

39. The device of claim 38, wherein the media data path has an 8 bit width.
